(19) United States
(12) Patent Application Publication
(10) Pub. No.: US 2006/0087784 A1
(43) Pub. Date: Apr. 27, 2006

(54) Over current protection device selection using active voltage sensing circuit

(75) Inventors: Ali S. Ba-Thunya, Round Rock, TX (US); Omar Bouderdaben, Round Rock, TX (US); Thomas Garvens, Austin, TX (US); Lynn Simmons, Austin, TX (US)

Correspondence Address: Paul N. Katz, One Shell Plaza, 910 Louisiana, Houston, TX, 77002, US

(73) Assignee: Dell Products L.P.

(21) Appl. No.: 10/974,114

(22) Filed: Oct. 27, 2004

(51) Int. Cl. H02H 3/08

(52) U.S. Cl. 361/93.1

(57) ABSTRACT

An information handling system has a power supply that is adapted to work over a wide range of utility supply voltages. The power supply automatically selects an over current protective device having the correct current overload characteristics for the utility supply voltage at which the power supply operates. A voltage determining detector selects the appropriate over current protective device based upon the utility supply voltage.

### BACKGROUND OF THE INVENTION TECHNOLOGY

1. Field of the Invention

The present invention is related to information handling systems, and, more specifically, to automatic over current protection device selection in a power supply of the information handling system.

2. Description of the Related Art

As the value and use of information continues to increase, individuals and businesses seek additional ways to process and store information. One option available to users are information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, RAID disk system and telecommunications switch.

For economics of scale and ease in manufacturing and inventory, information handling systems must be designed for sale and utilization anywhere in the world. The information handling system requires a power supply that converts utility power to voltages useable by the information handling system. However, utility power specifications, e.g., supply voltage may be substantially different in different countries and/or different parts of the world, e.g., USA—120 volts, Japan—100 volts, Europe—240 volts, etc. The power supply may adapt to these various world wide utility voltages by automatically selecting an operating voltage compatible with the connected utility voltage. A power supply is rated for a maximum power capacity in watts or volt-amperes (VA) and the input supply source over current protection device, e.g., fuse or circuit breaker, must be sized proportionally for the specific voltage range at which the power supply is being operated. An over current protection device must be sized in amperes to match the input supply voltage relative to the power supply power rating. This requires using an over current protection device having a different overload current value for each different voltage range. Therefore, different over current protection devices must be used in different countries, depending upon the available utility supply voltage. In addition, different countries have electrical codes requiring a certain maximum current overload rating for a given wattage power supply.

Therefore, what is needed is a solution for having to physically change current protection devices in a power supply of an information handling system when connected to different supply voltage sources.

### SUMMARY OF THE INVENTION

The invention remedies the shortcomings of the prior art by providing an information handling system power supply having different current protection devices that may be automatically selectable based upon particular ranges of supply voltages. An information handling system has a power supply that is adapted to receive power from a utility power source and provide voltages necessary to power the information handling system. The power supply is adapted to operate over various utility supply voltages found throughout the world, and to automatically select an appropriate over current protection device based upon the utility supply voltage source connected thereto. Voltage sensing determines which one of a plurality of defined voltage ranges of a utility power source to which the power supply is connected. For example, a low voltage range may be defined as a utility voltage of from about 85 volts to about 140 volts, and a high voltage range may be defined as a utility voltage of from about 180 volts to about 264 volts. It is contemplated and within the scope of the present invention that more voltage ranges and/or different voltages defining a voltage range may be used with the present invention.

First and second over current protection devices may be associated with first and second utility power source voltage ranges. The ratings of the first and second over current protection devices may be selected for proper protection of the power supply when operating at the first and second utility power source voltage ranges, respectively. In addition the current protection values of the first and second over current protection devices may be selected to meet appropriate electrical code requirements of a country in which the information handling system power supply is being used. The high voltage range will be associated with an over current protective device having a lower current protection value, and the low voltage range will be associated with an over current protective device having a higher current protection value.

According to an exemplary embodiment of the invention, a voltage sensing circuit determines the voltage range of the utility source and then selects an appropriate over current protection device for protection of the power supply. The first and second over current protection devices may be connected in series between the utility source and power supply circuits, the first current protection device having a higher current rating than the second current protection device. A normally open contact of a relay may be connected in parallel with the second current protection device such that when the voltage sensing circuit determines that the first over current protection device is the appropriate one for the connected utility source voltage (low voltage range), the voltage sensing circuit causes the normally open contact of the relay to close (energizes the relay coil) so as to short out the second current protection device. Since the second current protection device is shorted, the first current protection device is the only protection circuit between the utility source and the power supply circuits. Any failure of the relay coil will automatically place the second current protection device back between the utility source and power supply circuits. Thus, failsafe operation is assured in that the connected over current device will always be within a safe and code compliant rating.

According to another exemplary embodiment of the invention, a voltage sensing circuit determines the voltage range of the utility source and then selects an appropriate over current protection device for protection of the power supply. The first and second over current protection devices may be selectively connected between the utility source and power supply circuits, the first current protection device having a higher current rating than the second current protection device. A normally open contact of a relay may be connected in series with the first current protection device and a normally closed contact of the relay may be connected in series with the second current protection device. Wherein when the voltage sensing circuit determines that the first over current protection device is the appropriate one for the connected utility source voltage (low voltage range), the voltage sensing circuit causes the normally open contact of the relay to close and the normally closed contact to open (energizes the relay coil) and thereby connects the utility source to the power supply circuit through only the first over current protection device. When the voltage sensing circuit determines that the second over current protection device is the appropriate one for the connected utility source voltage (high voltage range), the voltage sensing circuit does not energize the relay coil, thus the normally closed contact of the relay connects the utility source to the power supply circuit through only the second over current protection device. Any failure of the relay coil will automatically place the second current protection device between the utility source and power supply circuits. Thus, failsafe operation is assured in that the connected over current device will always be within a safe and code compliant rating.

In the exemplary embodiments disclosed herein, the relay may be, for example, an electromechanical contact power relay having a coil driven by a solid state switch, e.g., bipolar transistor or field effect transistor (FET), and a voltage snubbing diode may be placed across the power relay coil. The voltage sensing circuit may be a simple voltage comparator circuit having an output that drives the solid state switch to on and off states.

A technical advantage of the present invention is automatic selection of a correctly rated over current protective device of a power supply for a respective source supply voltage range. Another technical advantage is failsafe selection of a correctly rated over current protective device of a power supply for a respective source supply voltage range. Other technical advantages should be apparent to one of ordinary skill in the art in view of what has been disclosed herein.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a schematic block diagram of an exemplary embodiment of an information handling system in combination with the invention;

FIG. 2 is a schematic diagram of an automatic over current protection selection circuit, according to a specific exemplary embodiment of the invention; and

FIG. 3 is a schematic waveform of an automatic over current protection selection circuit, according to another specific exemplary embodiment of the invention.

The present invention may be susceptible to various modifications and alternative forms. Specific exemplary embodiments thereof are shown by way of example in the drawing and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of specific exemplary embodiments of the present invention are schematically illustrated. Like elements in the drawings will be represented by like numbers, and similar elements will be represented by like numbers with a different lower case letter suffix.

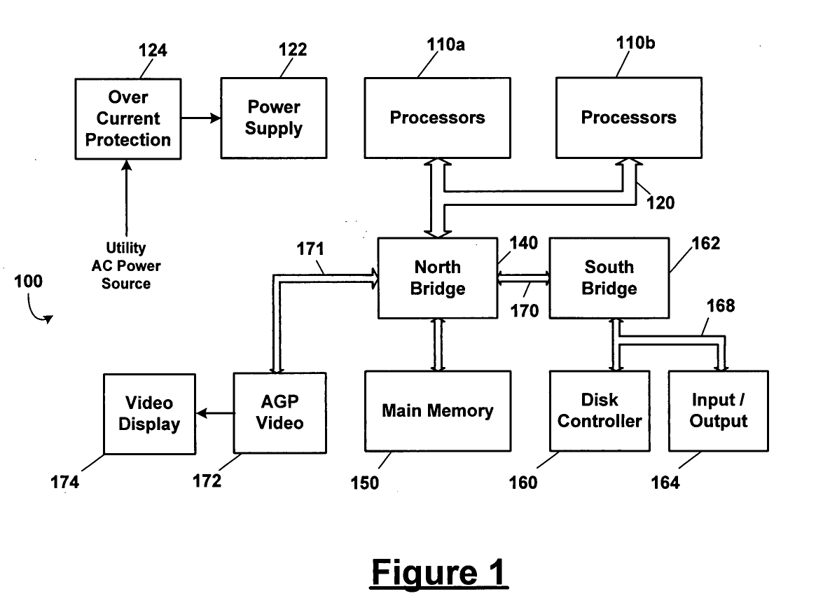

Referring to FIG. 1, an information handling system is illustrated having electronic components mounted on at least one printed circuit board (PCB) (motherboard) and communicating data and control signals therebetween over signal buses. In one embodiment, the information handling system is a computer system. The information handling system, generally referenced by the numeral 100, comprises a processor(s) 110 coupled to a host bus 120. A north bridge 140, which may also be referred to as a memory controller hub or a memory controller, is coupled to a main system memory 150. The north bridge 140 is coupled to the system processor(s) 110 via the host bus(es) 120. The north bridge 140 is generally considered an application specific chip set that provides connectivity to various buses, and integrates other system functions such as a memory interface. For example, an Intel 820E and/or 815E chip set, available from the Intel Corporation of Santa Clara, Calif., provides at least a portion of the north bridge 140. The chip set may also be packaged as an application specific integrated circuit (ASIC). The north bridge 140 typically includes functionality to couple the main system memory 150 to other devices within the information handling system 100. Thus, memory controller functions, such as main memory control functions, typically reside in the north bridge 140. In addition, the north bridge 140 provides bus control to handle transfers between the host bus 120 and a second bus(es), e.g., PCI bus 170, AGP bus 171 coupled to video graphics display 174, etc. A second bus(es) 168 may also comprise other industry standard buses or proprietary buses, e.g., ISA, SCSI, USB buses through a south bridge(s) (bus interface) 162. These secondary buses 168 may have their own interfaces and controllers, e.g., ATA disk controller 160 and input/output interface(s) 164, and interface with a disk controller, a network interface card, a graphics controller, a hard disk and the like. A power supply 122 is coupled to and powers the information handling system 100. An over current protection device 124 protects the power supply 122 power input.

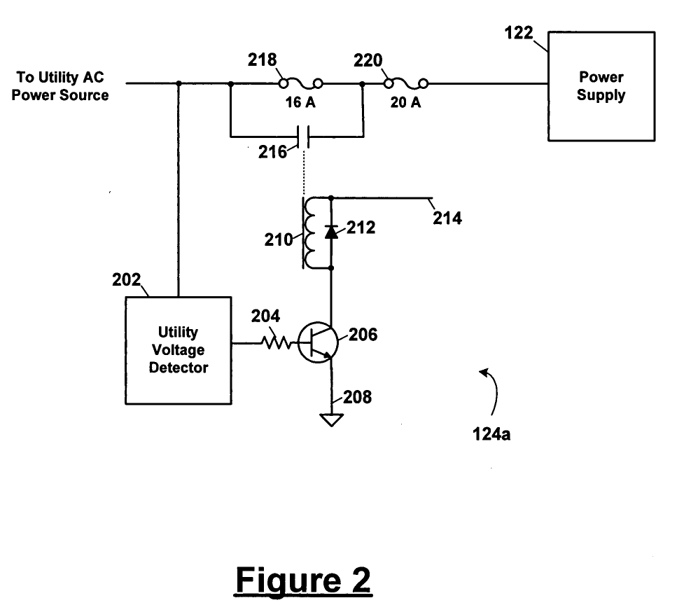

Referring to FIG. 2, depicted is a schematic diagram of an automatic over current protection selection circuit, according to a specific exemplary embodiment of the invention. The over current protection selection circuit is generally represented by the numeral 124a. The over current protection selection circuit 124a couples the power supply 122 to a utility AC power source. The over current protection selection circuit 124a protects the power supply 122, and also may be configured for compliance with state and country electrical codes. According to this specific exemplary embodiment, a utility voltage detector 202 determines in what voltage range the utility AC power source is at. For example, a low voltage range may be defined as a utility voltage of from about 85 volts to about 140 volts, and a high voltage range may be defined as a utility voltage of from about 180 volts to about 264 volts. It is contemplated and within the scope of the present invention that more voltage ranges and/or different voltages defining a voltage range may be used with the present invention.

The utility voltage detector 202 may rectify the AC utility voltage to a DC voltage and then compare the DC voltage to a voltage reference using a simple voltage comparator wherein the utility voltage detector 202 may have an output at a first logic level when the utility voltage is less than a certain voltage, e.g., 180 volts, and at a second logic level when the utility voltage is greater than or equal to the certain voltage (e.g., 180 volts). The utility voltage detector 202 output drives a switching transistor 206 through a current limiting resistor 204. The switching transistor 206 controls a relay coil 210. Switching transistor 206 turns on (saturates) when the output of the utility voltage detector 202 is at the first logic level, thereby energizing the relay coil 210 from a voltage source 214. A common or ground 208 to the voltage source 214 may be connected to the switching transistor 206. The relay coil 210 and the switching transistor 206 may be reversed in connection to the voltage source 214 and ground 208. A counter EMF snubbing diode 212 may be connected in parallel with the relay coil 214 so as to reduce transient voltages on the transistor 206. The transistor 206 may be any type of switching transistor, e.g., bipolar transistor, field effect transistor, etc.

A first current protection device 220 and a second over current protection device 218 may be connected in series between the utility AC power source and the power supply 122, the first current protection device 220 has a higher current rating than the second current protection device 218. A normally open contact 216 of a power relay may be connected in parallel with the second current protection device 218 such that when the utility voltage detector 202 determines that the first over current protection device 220 is the appropriate one for the connected utility source voltage (low voltage range), the utility voltage detector 202 causes the normally open contact 216 of the relay to close (energizes the relay coil 210) so as to short out the second current protection device 218. Since the second current protection device 218 is shorted, the first current protection device 220 is the only over current protection between the utility AC power source and the power supply 122. Any failure of the relay coil 210 will automatically place the second current protection device 218 back between the utility AC power source and power supply 122. Thus, failsafe operation is assured in that the connected over current protection device 218 will always be within a safe and code compliant rating for any voltage if the relay coil fails. It is contemplated and within the scope of the present invention that more than two over current protection devices may be connected in series and the over current devices not required may be shorted out by a plurality of relay contacts (not shown) for use with a plurality of utility voltage ranges, respectively.

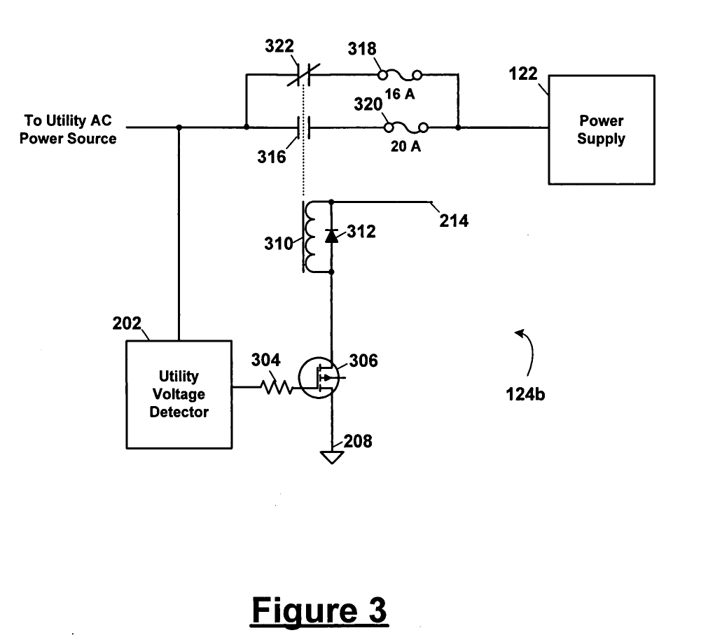

Referring to FIG. 3, depicted is a schematic waveform of an automatic over current protection selection circuit, according to another specific exemplary embodiment of the invention. The over current protection selection circuit is generally represented by the numeral 124b. The over current protection selection circuit 124b couples the power supply 122 to a utility AC power source. The over current protection selection circuit 124b protects the power supply 122, and also may be configured for compliance with state and country electrical codes. According to this specific exemplary embodiment, a utility voltage detector 202 determines in what voltage range the utility AC power source is at. For example, a low voltage range may be defined as a utility voltage of from about 85 volts to about 140 volts, and a high voltage range may be defined as a utility voltage of from about 180 volts to about 264 volts. It is contemplated and within the scope of the present invention that more voltage ranges and/or different voltages defining a voltage range may be used with the present invention.

The utility voltage detector 202 may rectify the AC utility voltage to a DC voltage and then compare the DC voltage to a voltage reference using a simple voltage comparator wherein the utility voltage detector 202 may have an output at a first logic level when the utility voltage is less than a certain voltage, e.g., 180 volts, and at a second logic level when the utility voltage is greater than or equal to the certain voltage (e.g., 180 volts). The utility voltage detector 202 output drives a switching transistor 306 through a current limiting resistor 304. The switching transistor 306 controls a relay coil 310. Switching transistor 306 turns on (saturates) when the output of the utility voltage detector 202 is at the first logic level, thereby energizing the relay coil 310 from a voltage source 214. A common or ground 208 to the voltage source 214 may be connected to the switching transistor 306. The relay coil 310 and the switching transistor 306 may be reversed in connection to the voltage source 214 and ground 208. A counter EMF snubbing diode 312 may be connected in parallel with the relay coil 314 so as to reduce transient voltages on the transistor 306. The transistor 306 may be any type of switching transistor, e.g., bipolar transistor, field effect transistor, etc.

A first current protection device 320 and a second over current protection device 318 may be commonly connected to the power supply 122. The first current protection device 220 has a higher current rating than the second current protection device 218. A normally open contact 316 of a power relay may be connected in series with the second current protection device 318. A normally closed contact 322 of the power relay may be connected in series with the second current protection device 318. When the utility voltage detector 202 determines that the first over current protection device 320 is the appropriate one for the connected utility source voltage (low voltage range), the utility voltage detector 202 causes the normally open contact 316 of the relay to close (energizes the relay coil 310) so as to connect the first current protection device 320 to the utility AC power source. Since the normally closed contact 322 is now open, the second current protection device 218 is not in the circuit between the utility AC power source and the power supply 122. The first current protection device 320 is the only over current protection between the utility AC power source and the power supply 122. When the utility voltage detector 202 output is at the second logic level then the switching transistor 306 is off and the relay coil 310 is not energized, thus the normally closed contact 322 connects the second over current protective device 318 to the utility AC power source (high voltage range) and the first over current protective device 320 is not in the power flow circuit.

Any failure of the relay coil 310 will automatically place the second current protection device 318 back between the utility AC power source and power supply 122 and disconnect the first current protection device 320. Thus, failsafe operation is assured in that the connected over current protection device 318 will always be within a safe and code compliant rating for any voltage if the relay coil 310 fails. It is contemplated and within the scope of the present invention that more than two over current protection devices may be connected in series and the over current devices not required may be shorted out by a plurality of relay contacts (not shown) for use with a plurality of utility voltage ranges, respectively.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. An information handling system having a power supply with automatic selection of over current protection for different supply voltages, said system comprising:
an information handling system having a power supply, the power supply adapted for receiving power from a power source and providing voltages necessary to power the information handling system, the power supply having input power over current protection device selection, wherein the input power over current protection device selection comprises:
a voltage detector having an input coupled to the power source and an output, wherein the output is at a first logic level when the power source voltage is less than a certain voltage level and at a second logic level when the power source voltage is equal to or greater than the certain voltage level;
a first over current protection device; and
a second over current protection device, wherein
the power supply is coupled to the power source through the first over current protection device when the voltage detector output is at the first logic level, and
the power supply is coupled to the power source through the second over current protection device when the voltage detector output is at the second logic level.

2. The information handling system according to claim 1, wherein the voltage detector comprises a voltage comparator.

3. The information handling system according to claim 1, wherein the first and second over current protection devices are connected in series between the utility power source and the power supply.

4. The information handling system according to claim 3, wherein the second over current protection device is bypassed when the voltage detector output is at the first logic level.

5. The information handling system according to claim 4, wherein the second over current protection device is bypassed with a relay contact connected in parallel therewith.

6. The information handling system according to claim 5, wherein the relay contact is controlled with a relay coil coupled to the output of the voltage detector.

7. The information handling system according to claim 6, wherein the relay coil is coupled to the output of the voltage detector with a switching transistor.

8. The information handling system according to claim 7, wherein the switching transistor is a bipolar transistor.

9. The information handling system according to claim 7, wherein the switching transistor is a field effect transistor.

10. The information handling system according to claim 1, wherein:
the first and second over current protection devices are connected to the power supply;
the first over current device is connected to the utility power source with a normally open contact of a relay; and
the second over current device is connected to the utility power source with a normally closed contact of the relay, wherein when the voltage detector output is at the first logic level the power relay is energized.

11. The information handling system according to claim 10, wherein the relay is controlled with a relay coil coupled to the output of the voltage detector.

12. The information handling system according to claim 11, wherein the relay coil is coupled to the output of the voltage detector with a switching transistor.

13. The information handling system according to claim 12, wherein the switching transistor is a bipolar transistor.

14. The information handling system according to claim 12, wherein the switching transistor is a field effect transistor.

15. The information handling system according to claim 1, wherein the certain voltage is about 180 volts.

16. The information handling system according to claim 1, wherein the first over current protection device has a higher current rating then the second over current protection device.

17. The information handling system according to claim 1, wherein the first over current protection device is a fuse.

18. The information handling system according to claim 1, wherein the first over current protection device is a circuit breaker.

19. The information handling system according to claim 1, wherein the second over current protection device is a fuse.

20. The information handling system according to claim 1, wherein the second over current protection device is a circuit breaker.

21. A method of selecting over current protection for a power supply adapted for operating from different supply voltages, said method comprising the steps of:
providing a power supply in an information handling system that receives power from an external power source and provides voltages necessary to power the information handling system, the power supply having input power over current protection device selection, wherein the input power over current protection device selection comprises the steps of:
detecting a voltage of the external power source;
coupling the power supply to the external power source with a first over current protection device if the detected voltage is less than a certain voltage; and
coupling the power supply to the external power source with a second over current protection device if the detected voltage is equal to or greater than the certain voltage.

22. The method according to claim 21, wherein the step of detecting the voltage is done with a voltage comparator.

23. The method according to claim 21, wherein the step of coupling is done with a relay.

24. The method according to claim 21, wherein the certain voltage is about 180 volts.

25. An apparatus for selecting over current protection for a power supply adapted for operating from different supply voltages, comprising:
a power supply adapted for receiving power from a power source, the power supply having input power over current protection device selection, wherein the input power over current protection device selection comprises:
a voltage detector having an input coupled to the power source and an output, wherein the output is at a first logic level when the power source voltage is less than a certain voltage level and at a second logic level when the power source voltage is equal to or greater than the certain voltage level;
a first over current protection device; and
a second over current protection device, wherein
the power supply is coupled to the power source through the first over current protection device when the voltage detector output is at the first logic level, and
the power supply is coupled to the power source through the second over current protection device when the voltage detector output is at the second logic level.

26. The apparatus according to claim 25, wherein the voltage detector comprises a voltage comparator.

27. The apparatus according to claim 25, wherein the first and second over current protection devices are connected in series between the utility power source and the power supply.

28. The apparatus according to claim 27, wherein the second over current protection device is bypassed when the voltage detector output is at the first logic level.

29. The apparatus according to claim 28, wherein the second over current protection device is bypassed with a relay contact connected in parallel therewith.

30. The apparatus according to claim 29, wherein the relay contact is controlled with a relay coil coupled to the output of the voltage detector.

31. The apparatus according to claim 30, wherein the relay coil is coupled to the output of the voltage detector with a switching transistor.

32. The apparatus according to claim 31, wherein the switching transistor is a bipolar transistor.

33. The apparatus according to claim 31, wherein the switching transistor is a field effect transistor.

34. The apparatus according to claim 25, wherein:
the first and second over current protection devices are connected to the power supply;
the first over current device is connected to the utility power source with a normally open contact of a relay; and
the second over current device is connected to the utility power source with a normally closed contact of the relay, wherein when the voltage detector output is at the first logic level the power relay is energized.

35. The apparatus according to claim 34, wherein the relay is controlled with a relay coil coupled to the output of the voltage detector.

36. The apparatus according to claim 35, wherein the relay coil is coupled to the output of the voltage detector with a switching transistor.

37. The apparatus according to claim 36, wherein the switching transistor is a bipolar transistor.

38. The apparatus according to claim 36, wherein the switching transistor is a field effect transistor.

39. The apparatus according to claim 25, wherein the certain voltage is about 180 volts.

40. The apparatus according to claim 25, wherein the first over current protection device has a higher current rating then the second over current protection device.

41. The apparatus according to claim 25, wherein the first over current protection device is a fuse.

42. The apparatus according to claim 25, wherein the first over current protection device is a circuit breaker.

43. The apparatus according to claim 25, wherein the second over current protection device is a fuse.

44. The apparatus according to claim 25, wherein the second over current protection device is a circuit breaker.
